(19) United States
(12) Patent Application Publication
(10) Pub. No.: US 2005/0163528 A1
(43) Pub. Date: Jul. 28, 2005

(54) Image producing machine having a footprint-reducing tower

(75) Inventors: Kenneth J. Rieck, Victor, NY (US); Murray O. Meetze JR., Rochester, NY (US)

Correspondence Address: Xerox Corporation;Patent Documentation Center, Xerox Square, 20th Floor, 100 Clinton Ave. S., Rochester, NY, 14644, US

(73) Assignee: Xerox Corporation

(21) Appl. No.: 10/767,603

(22) Filed: Jan. 28, 2004

(51) Int. Cl. G03G 15/00

(52) U.S. Cl. 399/107

(57) ABSTRACT

A reduced footprint image producing machine has functional components including image forming apparatus, controllers and machine environment conditioning devices; a first frame containing some of said functional components and having a height suitable for an operator work surface located at a top of said first frame; and a second frame mounted onto a top of said first frame defining a footprint-reducing tower, said footprint-reducing tower, thereby preventing the addition of protrusions to a rear of said machine, and thus reducing the installed foot print of the machine.

### BACKGROUND AND SUMMARY

This invention relates to an image producing machine architecture, and more particularly, concerns such a machine having a footprint-reducing tower module.

A typical image producing machine, for example an electrostatographic machine, includes an Image Output Terminal (IOT) that employs a photoconductive member that is charged to a substantially uniform potential so as to sensitize the surface thereof. The charged portion of the photoconductive member is exposed to a light image of an original document being reproduced. Exposure of the charged photoconductive member selectively dissipates the charge thereon in the irradiated areas to record an electrostatic latent image on the photoconductive member corresponding to the informational areas contained within the original document.

After the electrostatic latent image is recorded on the photoconductive member, the latent image is developed by bringing a developer material into contact therewith. Generally, the electrostatic latent image is developed with dry developer material comprising carrier granules having toner particles adhering triboelectrically thereto. However, a liquid developer material may be used as well. The toner particles are attracted to the latent image, forming a visible powder image on the photoconductive surface.

After the electrostatic latent image is developed with the toner particles, the toner powder image is transferred to a sheet. Thereafter, the toner image is heated to permanently fuse it to the sheet. An image producing machine of this type can be used to produce black and white as well as color prints or images.

In order to produce a color print, the image producing machine includes a plurality of stations. Each station has a charging device for charging the photoconductive surface, an exposing device for selectively illuminating the charged portions of the photoconductive surface to record an electrostatic latent image thereon, and a developer unit for developing the electrostatic latent image with toner particles. Each developer unit deposits different color toner particles on the respective electrostatic latent image. The images are developed, at least partially in superimposed registration with one another, to form a multi-color toner powder image. The resultant multi-color powder image is subsequently transferred to a sheet. The black and white or transferred multi-color image is then permanently fused to the sheet forming the color print.

The Image output Terminal (IOT) typically therefore includes a frame, image forming apparatus, drives, controllers, machine environment conditioning devices, and a user interface device that is built into the machine or that sits on top of the frame top cover taking up valuable work surface area. Because the height of such an IOT is a concern given the average height of potential operators, the machine environment conditioning devices and large controller electronics modules have conventionally been added onto the rear of the IOT in the form of protruding bustles. Such protrusions or bustles typically give the rear of the machine a complicated appearance, and undesirably add significantly to the size of the installed footprint of the machine. The installed footprint of any office or production environment machine is ordinarily considered to be prime real estate.

There is therefore a need for an image producing machine architecture that includes footprint-reducing features while also providing other advantages.

A reduced footprint image producing machine has functional components including image forming apparatus, controllers and machine environment conditioning devices; a first frame containing some of said functional components and having a height suitable for an operator work surface located at a top of said first frame; and a second frame mounted onto a top of said first frame defining a footprint-reducing tower, said footprint-reducing tower, thereby preventing the addition of protrusions to a rear of said machine, and thus reducing the installed foot print of the machine.

The present invention will become apparent from the following description in conjunction with the accompanying drawings, in which:

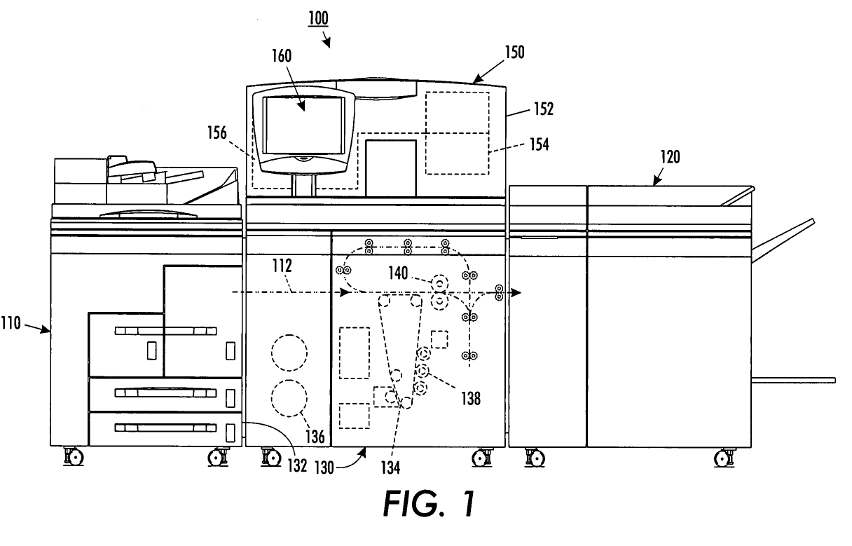

FIG. 1 is a schematic front view of an exemplary image producing machine showing the Image Output terminal (IOT) and the footprint-reducing tower in accordance with the present invention;

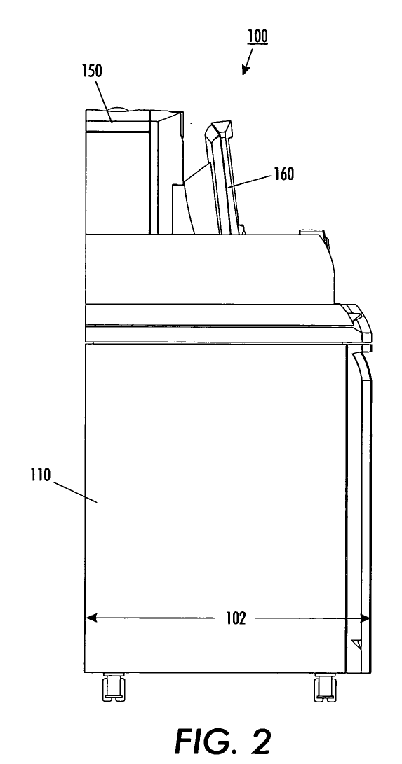

FIG. 2 is a schematic left side view of the exemplary image producing machine of FIG. 1 showing a clean up and down rear with no protrusions;

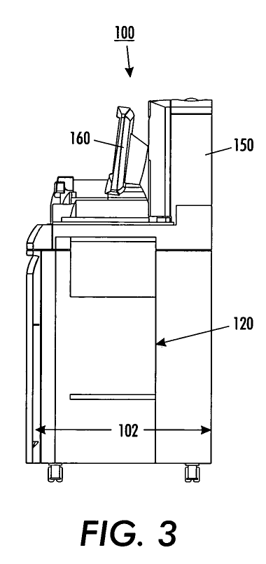

FIG. 3 is a schematic right side view of the exemplary image producing machine of FIG. 1 showing a clean up and down rear with no protrusions;

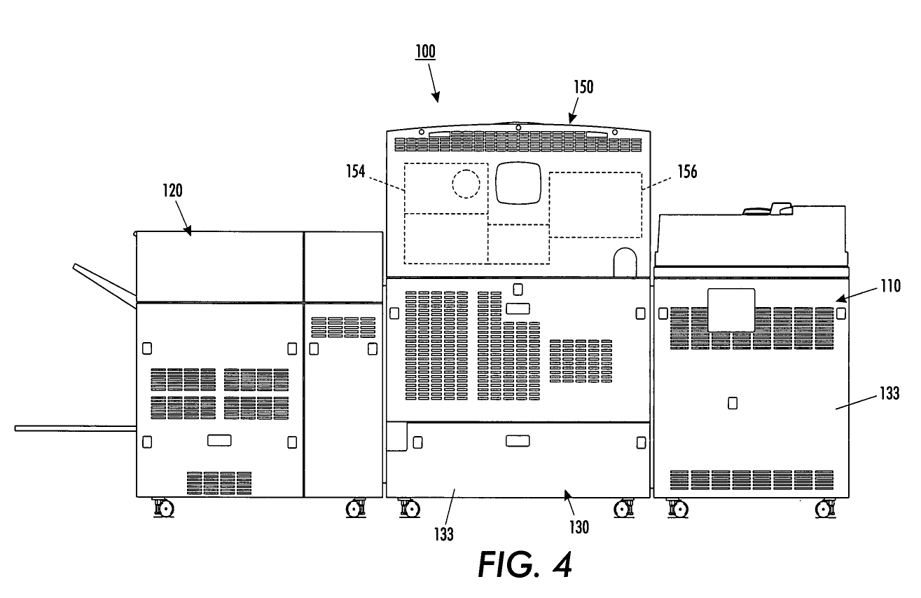

FIG. 4 is a schematic rear view of the exemplary image producing machine of FIG. 1 showing the footprint-reducing tower and the clean up and down rear with no protrusions;

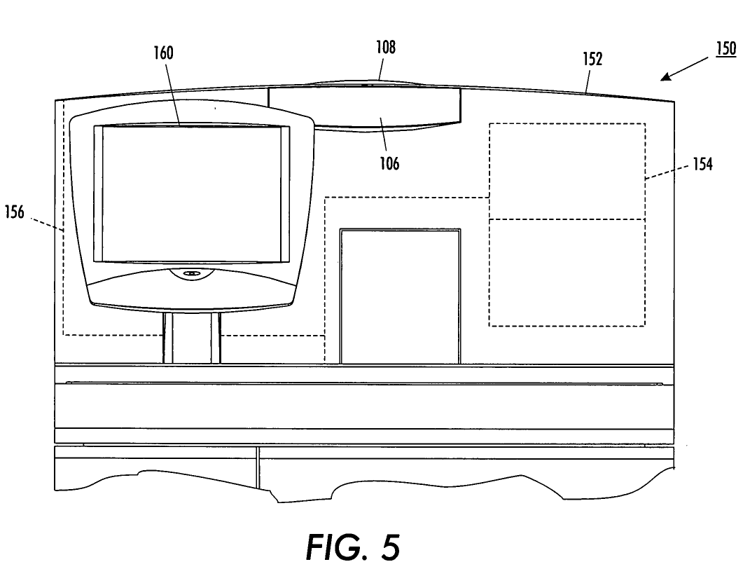

FIG. 5 is a schematic front view of the footprint-reducing tower of the present invention including and attached UI device;

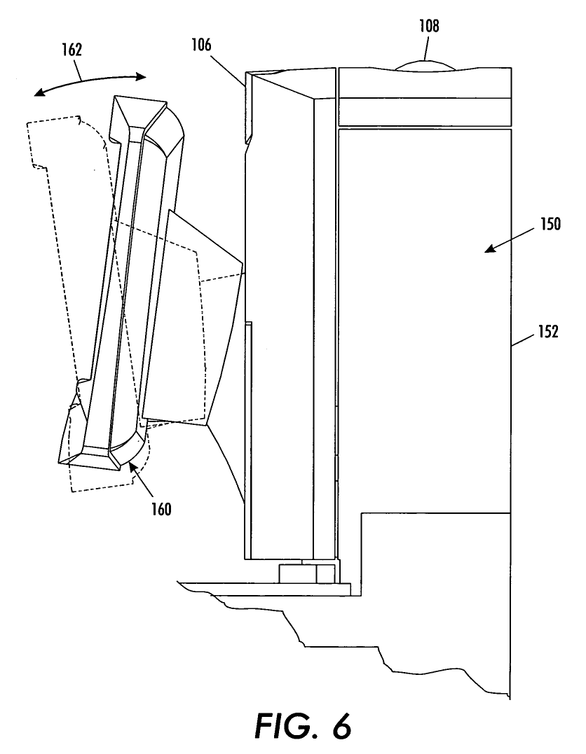

FIG. 6 is a schematic right side view of the footprint-reducing tower of the present invention showing up and down pivoting of the attached UI device; and

FIG. 6 is a schematic top view of the footprint-reducing tower of the present invention showing left and right pivoting of the attached UI device.

### DETAILED DESCRIPTION

Referring now to FIG. 1, an exemplary image producing machine 100 is shown and includes a paper or media holding and supply module 110, a finishing module 120, and an Image Output terminal (IOT) 130. Importantly, the machine 100 includes a footprint-reducing tower 150 that constitutes a functioning part of the IOT but is built as a second level frame 152, above the IOT frame 132, and significantly above an expected ordinary height of an IOT for such a machine. The IOT 130 for example includes image forming apparatus such as a photoreceptor belt 134, toner supply apparatus 136, development units 138, and a fusing apparatus 140. The IOT 130 also includes significant portions of paper or media handling path apparatus 112. Other functioning components of the IOT such as electronic controllers 154, machine environment conditioning devices 156, are conveniently mounted within the frame 152 of the footprint-reducing tower 150, instead of conventionally as protrusions or bustles to the rear of the IOT.

As shown in FIGS. 2-4, by mounting the electronics package or controllers 154, for example, to the top and back of the IOT frame 132, the rear or backside 133 of the machine 100 has no protrusions or bustles thereto, thus significantly reducing the installed footprint 102 of the machine 100. The machine 100 also therefore has a simple up and down and clean rear or backside, and so can be installed with safe walk areas to the front and rear of it. As a result, the service connections can be moved to the top of the machine, thus enabling an easier service access by technicians.

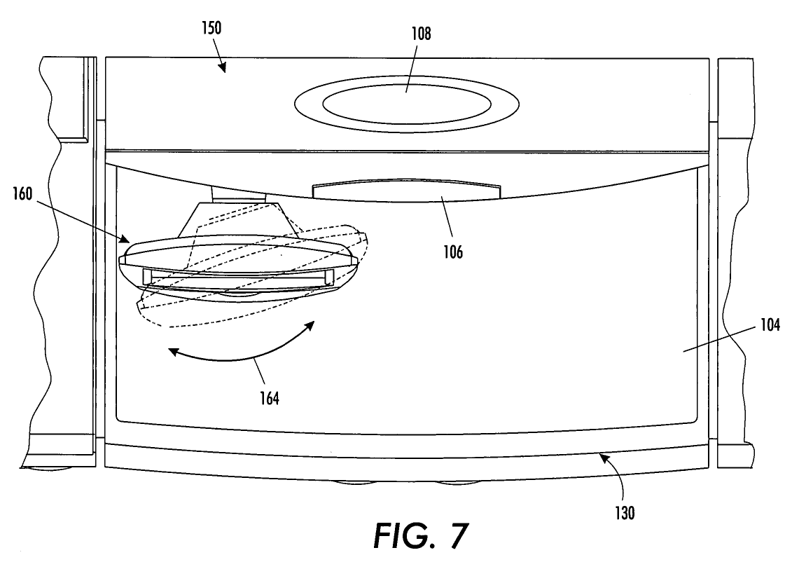

Referring now to FIGS. 5-7, further details of the footprint-reducing tower 150 are shown. The frame 152 of the footprint-reducing tower 150 is also made strong enough to support a mounted User Interface device 160. As shown in FIG. 7, mounting the UI device 160 to vertical of the frame 152 functions to free up significant work surface area 104 on the top of the IOT 130. The frame 152 is also used to carry an audible speaker assembly 106 and the machine's warning light 108.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A reduced footprint image producing machine comprising;
(a) Functional components including image forming apparatus, controllers and machine environment conditioning devices;
(b) a first frame containing some of said functional components and having a height suitable for an operator work surface located at a top of said first frame; and
(c) a second frame mounted onto a top of said first frame defining a footprint-reducing tower, said footprint-reducing tower, thereby preventing the addition of protrusions to a rear of said machine, and thus reducing the installed foot print of the machine.
